(19) United States
(12) Patent Application Publication
(10) Pub. No.: US 2026/0368661 A1
(43) Pub. Date: Nov. 19, 2026

(54) METHOD AND SYSTEM FOR MANAGING CONSTRUCTION SCHEDULE

(71) Applicants: Asahi Kasei Homes North America, INC., Tempe, AZ (US); Synergos Companies LLC, Scottsdale, AZ (US)

(72) Inventor: Rich GALLAGHER, Scottsdale, AZ (US)

(73) Assignees: Asahi Kasei Homes North America, INC., Tempe, AZ (US); Synergos Companies LLC, Scottsdale, AZ (US)

(21) Appl. No.: 19/139,997

(22) PCT Filed: Dec. 3, 2024
(86) PCT No.: PCT/US2024/058251

§ 371 Date: Jun. 17, 2025

Related U.S. Application Data
(63) Continuation of application No. 18/539,792, filed on Dec. 14, 2023, now abandoned.

(51) Int. Cl. G06Q 10/0631; G06Q 10/109; G06Q 50/08

(52) U.S. Cl. CPC G06Q 10/06312; G06Q 10/1097; G06Q 50/08

(57) ABSTRACT

A method for managing a construction schedule comprises: storing, by a computer, the construction schedule comprising phases including a first phase and a second phase scheduled to begin after the first phase begins, wherein the first phase comprises tasks including a first on-site task performed at a construction site and a first pre-task scheduled to begin before the first on-site task begins, and the second phase comprises tasks including a second on-site task performed at the construction site and a second pre-task scheduled to begin before the second on-site task begins; receiving, by the computer, first progress status data including progress status of the tasks in the first phase; updating, by the computer, the construction schedule based on the first progress status data to bring the second phase forward; and outputting, by the computer, the updated construction schedule. A system for managing a construction schedule is also provided.

### TECHNICAL FIELD

The present disclosure relates to a method and a system for managing a construction schedule.

### BACKGROUND

In recent years, technology for managing a schedule of construction of a building, a factory, a road, or the like has been developed. For example, US 2022-0215314 A1 discloses a system that generates a workflow including multiple tasks related to a construction project and updates the workflow in real-time according to status information of the tasks.

However, further improvement in the usefulness of the technology for managing a construction schedule has been demanded. For example, there exists a demand for dynamically rescheduling the start time of a certain phase included in a schedule depending on a progress status of a task included in another phase in the schedule.

### SUMMARY

It is, therefore, an object of the present disclosure to provide a method and a system for managing a construction schedule that is capable of further improving the efficiency of the management and optimizing the construction schedule.

In order to achieve the object, one aspect of the present disclosure is a method for managing a construction schedule, the method comprising:
storing, by a computer, the construction schedule comprising two or more phases including a first phase and a second phase scheduled to begin after the first phase begins, wherein the first phase comprises two or more tasks including a first on-site task performed at a construction site and a first pre-task scheduled to begin before the first on-site task begins, and the second phase comprises two or more tasks including a second on-site task performed at the construction site and a second pre-task scheduled to begin before the second on-site task begins;
receiving, by the computer, first progress status data including progress status of at least one of the tasks in the first phase;
updating, by the computer, the construction schedule based on the first progress status data to bring the second phase forward; and
outputting, by the computer, the updated construction schedule.

According to the above-mentioned method, a construction schedule can be dynamically updated according to the progress status of a task included in the construction schedule. Accordingly, the overall period of the construction schedule can be shortened, and the risk that the completion of the construction schedule will be delayed beyond the scheduled deadline can be reduced. Therefore, the method according to an embodiment of the present disclosure can further improve the efficiency of construction schedule management and optimize the construction schedule.

As used herein, the term “construction schedule” generally means a timeline for phases, tasks, and events in a construction project at a construction site. The construction schedule is referred to by workers of contractors participating in the construction project. In the present disclosure, a construction schedule comprises two or more phases.

As used herein, the term “construction site” generally means a place where a building, a factory, a road, or the like is constructed, but is not limited to these. The construction site is generally outdoors but may be indoors.

As used herein, the term “phase” generally means a distinct part or stage of the whole construction process that is necessary to complete a construction project. The phase includes, for example, a foundation work, an official inspection, a frame work, an air conditioning work, a water work, or an electrical work. In the present disclosure, a phase comprises two or more tasks.

As used herein, the term “task” generally means a defined item of work to be performed in a construction project. In the present disclosure, the tasks include, for example, an on-site task and a pre-task. However, the tasks may include any task in addition to the on-site task and the pre-task.

As used herein, the term “on-site task” generally means a task performed at a construction site.

As used herein, the term “pre-task” generally means a task that is scheduled to begin before the corresponding on-site task begins at a construction site. The pre-task may be performed on-site or off-site.

As used herein, the term “progress status data” generally means information including a progress status of at least one of the tasks included in a phase in a construction schedule.

Preferably, the updating the construction schedule comprises rescheduling the second on-site task to begin after the first on-site task ends in the construction schedule.

Additionally or alternatively, the updating the construction schedule preferably comprises rescheduling the second pre-task to begin before the first on-site task ends in the construction schedule.

Additionally or alternatively, the updating the construction schedule preferably comprises rescheduling at least one of the second pre-task or the second on-site task to shorten a time interval between the second pre-task and the second on-site task.

Each of the tasks in the second phase may be stored in association with a start condition, and the updating the construction schedule preferably comprises: determining a target task to be brought forward among the tasks in the second phase based on the first progress status data and the start condition of the each of the tasks; and bringing the target task forward.

Additionally or alternatively, each of the tasks in the second phase may be stored in association with a weather condition under which the each of the tasks can be performed, and the method may further comprise receiving, by the computer, weather information. In this state, the updating the construction schedule preferably comprises: determining a target task to be brought forward among the tasks in the second phase based on the first progress status data and the weather information; and bringing the target task forward.

The two or more phases may further include a third phase scheduled to begin after the second phase begins, and the third phase may comprise two or more tasks including a third on-site task performed at the construction site and a third pre-task scheduled to begin before the third on-site task begins. In this state, the method preferably further comprises: receiving, by the computer, second progress status data including progress status of at least one of the tasks in the second phase; and updating, by the computer, the construction schedule based on at least one of the first progress status data or the second progress status data to bring the third phase forward.

Additionally or alternatively, the two or more phases preferably further include one or more phases scheduled to begin after the first phase begins and before the second phase begins.

The first on-site task may be scheduled to begin after the first pre-task ends in the construction schedule, and the second on-site task may be scheduled to begin after the second pre-task ends in the construction schedule.

The second pre-task preferably comprises at least one of: finalizing a timeline of the second on-site task; arranging a worker for the second on-site task; requesting an additional worker for the second on-site task; waiting until a weather condition permits the second on-site task to be performed; or waiting until materials used in the second on-site task is delivered at the construction site.

The method preferably further comprises storing, by the computer, recipient information associated with the second phase; and upon bringing the second phase forward, selectively transmitting, by the computer, a notification to the recipient.

The method may further comprise storing, by the computer, worker information about availability of workers assigned to each of the tasks in the second phase, and the updating the construction schedule preferably comprises: determining a target task to be brought forward among the tasks in the second phase based on the first progress status data; and bringing the target task forward to a time slot where the worker assigned to the target task is available.

The method may further comprise storing, by the computer, worker information about availability of workers assigned to each of the tasks in the second phase, and the updating the construction schedule preferably comprises: determining a target task to be brought forward among the tasks in the second phase based on the first progress status data; bringing the target task forward to a new time slot; and in case where the worker assigned to the target task is not available at the new time slot, assigning another worker to the target task.

Another aspect of the present disclosure is a system for managing a construction schedule, the system comprising a controller configured to execute operations, the operations comprising:
storing the construction schedule comprising two or more phases including a first phase and a second phase scheduled to begin after the first phase begins, wherein the first phase comprises two or more tasks including a first on-site task performed at a construction site and a first pre-task scheduled to begin before the first on-site task begins, and the second phase comprises two or more tasks including a second on-site task performed at the construction site and a second pre-task scheduled to begin before the second on-site task begins;
receiving first progress status data including progress status of at least one of the tasks in the first phase;
updating the construction schedule based on the first progress status data to bring the second phase forward; and
outputting the updated construction schedule.

Preferably, the updating the construction schedule comprises rescheduling the second on-site task to begin after the first on-site task ends in the construction schedule.

Additionally or alternatively, the updating the construction schedule preferably comprises rescheduling the second pre-task to begin before the first on-site task ends in the construction schedule.

Additionally or alternatively, the updating the construction schedule preferably comprises rescheduling at least one of the second pre-task or the second on-site task to shorten a time interval between the second pre-task and the second on-site task.

Each of the tasks in the second phase may be stored in association with a start condition, and the updating the construction schedule comprises: determining a target task to be brought forward among the tasks in the second phase based on the first progress status data and the start condition of the each of the tasks; and bringing the target task forward.

Additionally or alternatively, each of the tasks in the second phase may be stored in association with a weather condition under which the each of the tasks can be performed, and the operations may further comprise receiving weather information. In this state, the updating the construction schedule preferably comprises: determining a target task to be brought forward among the tasks in the second phase based on the first progress status data and the weather information; and bringing the target task forward.

The two or more phases may further include a third phase scheduled to begin after the second phase begins, and the third phase may comprise two or more tasks including a third on-site task performed at the construction site and a third pre-task scheduled to begin before the third on-site task begins. In this state, the operations preferably further comprises: receiving second progress status data including progress status of at least one of the tasks in the second phase; and updating the construction schedule based on at least one of the first progress status data or the second progress status data to bring the third phase forward.

The second pre-task preferably comprises at least one of: finalizing a timeline of the second on-site task; arranging a worker for the second on-site task; requesting an additional worker for the second on-site task; waiting until a weather condition permits the second on-site task to be performed; or waiting until materials used in the second on-site task is delivered at the construction site.

The operations preferably further comprise: storing recipient information associated with the second phase; and upon bringing the second phase forward, selectively transmitting a notification to the recipient.

Additionally or alternatively, the operations may further comprise: storing worker information about availability of workers assigned to each of the tasks in the second phase. In this state, the updating the construction schedule preferably comprises: determining a target task to be brought forward among the tasks in the second phase based on the first progress status data; and bringing the target task forward to a time slot where the worker assigned to the target task is available.

Additionally or alternatively, the operations may further comprise: storing worker information about availability of workers assigned to each of the tasks in the second phase. In this state, the updating the construction schedule further comprises: determining a target task to be brought forward among the tasks in the second phase based on the first progress status data, bringing the target task forward to a new time slot; and in case where the worker assigned to the target task is not available at the new time slot, assigning another worker to the target task.

### BRIEF DESCRIPTION OF THE DRAWINGS

Various other objects, features and attendant advantages of the present disclosure will become fully appreciated as the same becomes better understood when considered in conjunction with the accompanying drawings, in which like reference characters designate the same or similar parts throughout the several views, and wherein:

FIG. 1 is a block diagram showing a schematic configuration of a construction schedule management system according to an embodiment of the present disclosure;

FIG. 2 is a flowchart showing a first operational example of a construction schedule management system shown in FIG. 1;

FIG. 3 is a block diagram showing a schematic configuration of a server device shown in FIG. 1;

FIG. 4 is a block diagram showing a schematic configuration of a user device shown in FIG. 1;

FIG. 5 is an example of a construction schedule according to the present disclosure;

FIG. 6 is an updated example of the construction schedule shown in FIG. 5;

FIG. 7 is a flowchart showing a second operational example of a construction schedule management system shown in FIG. 1;

FIG. 8 is another updated example of the construction schedule shown in FIG. 5; and

FIG. 9 is an example of a user interface for editing progress status of tasks.

### DETAILED DESCRIPTION

Embodiments will now be described with reference to the accompanying drawings.

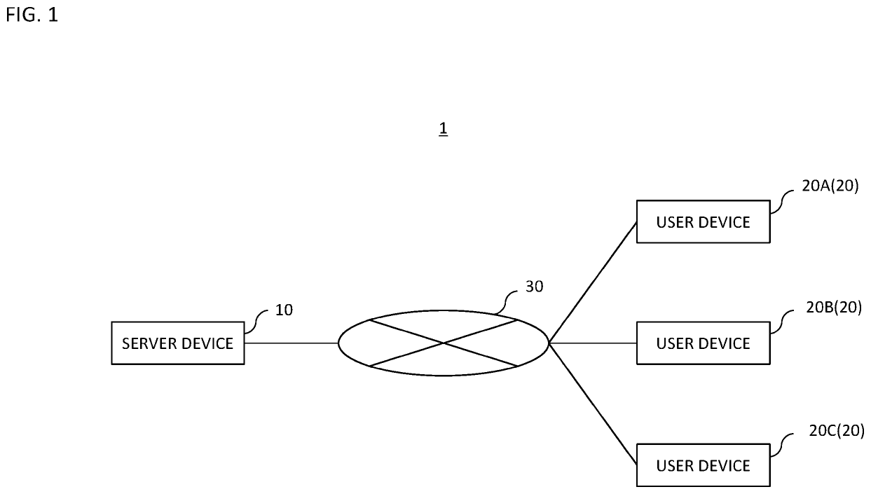

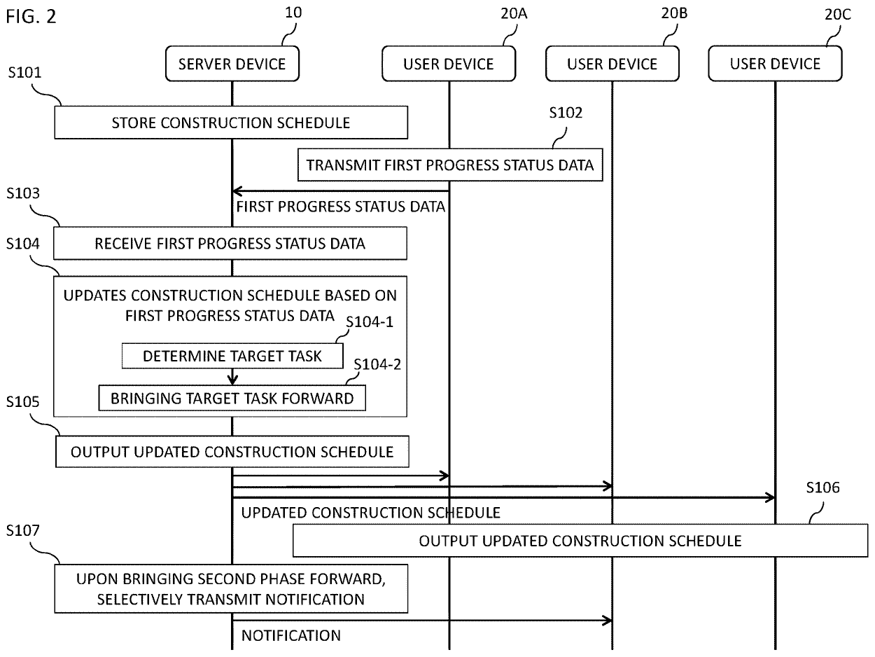

With reference to FIG. 1 and FIG. 2, an overview of a construction schedule management system 1 according to an embodiment of the present disclosure will be described. The construction schedule management system 1 is used, for example, to manage a schedule for tasks performed in a construction project. FIG. 1 is a block diagram showing a schematic configuration of the construction schedule management system 1 according to an embodiment of the present disclosure. FIG. 2 is a flowchart showing a first operational example of the construction schedule management system 1 shown in FIG. 1. As illustrated in FIG. 1, the construction schedule management system 1 includes a server device 10 and three user devices 20 (user devices 20A, 20B, 20C). Hereinafter, the user devices 20A, 20B, 20C are collectively referred to simply as the “user device 20” when no distinction therebetween is made.

The server device 10 is configured by one or more computers. In the present embodiment, the server device 10 may be configured by one computer or by computers configured to communicate with each other, such as a cloud computing system. In the following description, the server device 10 is also referred to as a construction schedule management apparatus.

The user device 20 is, for example, a personal computer, but is not limited thereto and may be any computer, such as a mobile phone, a tablet, a minicomputer, or a mainframe computer. In the present embodiment, the user device 20 is used by a user of the construction schedule management system 1. The user may be, for example, a worker of a contractor participating in a construction project.

For the sake of simplicity, FIG. 1 illustrates one server device 10 and three user devices 20. However, the construction schedule management system 1 may include any number of server devices 10 and user devices 20. The server device 10 and the user devices 20 are communicably connected to a network 30 including, for example, the Internet, a mobile communication network, or the like.

As illustrated in FIG. 2, the server device 10 stores a construction schedule comprising two or more phases including a first phase and a second phase scheduled to begin after the first phase begins. The server device 10 receives first progress status data including progress status of at least one of the tasks in the first phase from, for example, the user device 20A. The server device 10 updates the construction schedule based on the first progress status data to bring the second phase forward. The server device 10 outputs the updated construction schedule, for example, by transmitting it to the user devices 20A-20C.

According to the present embodiment, the construction schedule management system 1 can dynamically bring forward a task included in a construction schedule in relation to the progress status of other tasks included in the construction schedule. Accordingly, the construction schedule management system 1 can shorten the overall period of the construction schedule. Therefore, according to the present embodiment, it is possible to further improve the efficiency of construction schedule management and optimize the construction schedule.

In the present embodiment, a construction schedule is used for a construction project at a construction site. The construction schedule is referred to by workers of contractors participating in the construction project. The workers may refer to the construction schedule to understand the entire process of the construction project or confirm their own tasks.

In the present embodiment, the construction schedule comprises two or more phases. Each of the two or more phases may be associated with information such as a start timepoint, an end timepoint, a status, start conditions, end conditions, a contractor in charge, contact information thereof, and the like. The time slot from the start timepoint to the end timepoint of a phase may or may not be scheduled to overlap with the time slot of another phase in the construction schedule. In the present embodiment, each phase is to be assigned to one contractor. However, one phase may be assigned to two or more contractors.

In the present embodiment, the each of the two or more phases comprises two or more tasks. The tasks include an on-site task and a pre-task. However, the tasks may include any task in addition to the on-site task and the pre-task. The on-site task is performed at the construction site. The on-site task may be any task performed at the construction site and includes, but not limited to, assembling or painting materials at a construction site, installing or removing necessary temporary structures, such as fences, handrails, or scaffolding, at a construction site, performing work based on construction drawings necessary to complete a construction goal, and/or carrying out physical work or manufacturing at a construction site. In one construction schedule, two or more on-site tasks, respectively included in a different phase, are preferably not scheduled to be performed simultaneously at the construction site. Thereby, it is possible to reduce the risk that one of the tasks simultaneously performed in the construction site will interfere with the progress of the other task or tasks, and therefore reduce the risk that the construction schedule will be delayed. However, two or more on-site tasks may be scheduled to be performed simultaneously in one construction schedule.

The on-site task is scheduled to begin before the corresponding on-site task begins at a construction site. The pre-task may be performed on-site or off-site and includes, but not limited to, creating estimates, creating construction plans, arranging workers, managing logistics of materials (purchasing or shipping materials), and/or placing orders. Illustrative examples of the pre-task include assembling all or some of components in advance at a factory, drilling holes in components for electrical wiring, checking the number of components for each construction site and bundling the components for pick-up, estimating materials for constructing temporary structures at each construction site and bundling the materials for pick-up, creating a mold used at a construction site, cutting electrical wiring to a pre-specified length (pre-cutting), and/or distributing necessary construction drawings. The pre-task comprises at least one of: finalizing a timeline of the corresponding on-site task; arranging a worker for the corresponding on-site task; requesting an additional worker for the corresponding on-site task; waiting until a weather condition permits the corresponding on-site task to be performed; or waiting until materials used in the corresponding on-site task is delivered at the construction site. However, the pre-task may comprise any task in addition to the above-mentioned tasks. By distinguishing between pre-tasks and on-site tasks, it is possible to update the construction schedule with high accuracy and optimize the construction schedule.

In the present embodiment, each of the two or more tasks may be associated with information such as a start timepoint, an end timepoint, a status, start conditions, end conditions, a weather condition under which the each of the tasks can be performed, a worker or a contractor in charge, contact information thereof, and the like. Moreover, although each task is to be assigned to one worker of one contractor, one task may be assigned to two or more workers.

### Configurations of Server Device

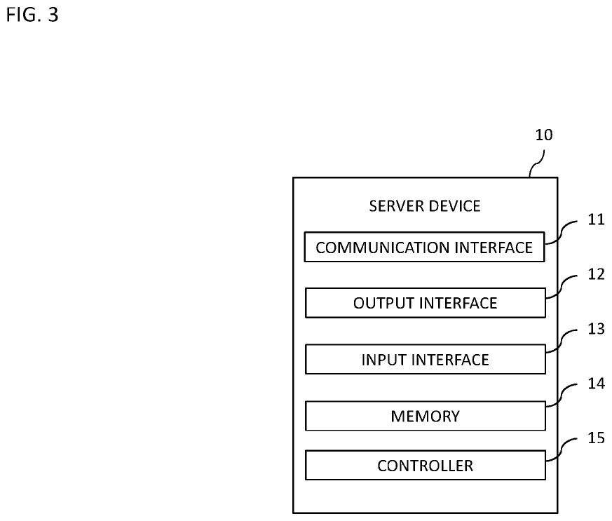

Referring now to FIG. 3, configurations of the server device 10 will be explained in detail. FIG. 3 is a block diagram illustrating a schematic configuration of the server device 10 shown in FIG. 1.

As illustrated in FIG. 3, the server device 10 includes a communication interface 11, an output interface 12, an input interface 13, a memory 14, and a controller 15. The communication interface 11, the output interface 12, the input interface 13, the memory 14, and the controller 15 are communicably connected to each other in a wired or wireless manner.

The communication interface 11 includes a communication module for connecting to the network 30. The communication module is, for example, a communication module compliant with a mobile communication standard such as the 4th Generation (4G) standard or the 5th Generation (5G) standard. The communication module may be, for example, a communication module compliant with a standard such as a wired Local Area Network (LAN) standard or a wireless LAN standard. The communication module may be a communication module compliant with a short-range wireless communication standard such as Wi-Fi, Bluetooth®, or an infrared communication standard. In the present embodiment, the server device 10 is connected to the network 30 via the communication interface 11. This enables the server device 10 to communicate with the user devices 20A-20C, and the like.

The output interface 12 includes at least one output device. The output device included in the output interface 12 is, for example, a display, a speaker, a lamp, or the like. The output interface 12 outputs images, sound, light, or the like.

The input interface 13 includes an input device. The input device included in the input interface 13 may, for example, be a keyboard, a mouse, a touch panel, a camera, a microphone, or the like. The input interface 13 accepts input operations from a user.

The memory 14 is, for example, a semiconductor memory, a magnetic memory, an optical memory, or the like. The memory 14 may function as, for example, a main memory, an auxiliary memory, or a cache memory. The memory 14 stores any information used for operations of the server device 10. For example, the memory 14 stores a system program, an application program, a database, embedded software, or the like. The information stored in the memory 14 may be updated with, for example, information acquired from the network 30 via the communication interface 11.

The memory 14 stores, for example, information such as a construction schedule. The memory 14 may also store information regarding a construction site, information regarding a building, information regarding weather, information regarding a phase, information regarding a task, information regarding a contractor, information regarding a worker, and the like. The memory 14 may store these pieces of information in association with each other and function as a database.

The controller 15 includes at least one processor. The processor may be, for example, a general-purpose processor such as a Central Processing Unit (CPU), a dedicated processor that is dedicated to specific processing, or the like. The controller 15 is not limited to a processor and may include at least one dedicated circuit. Examples of dedicated circuits may include a Field-Programmable Gate Array (FPGA) and an Application Specific Integrated Circuit (ASIC). The controller 15 controls the above-described components such as the communication interface 11, the output interface 12, the input interface 13, and the memory 14 to realize the functions of the server device 10, including the functions of these components.

### Configuration of User Device

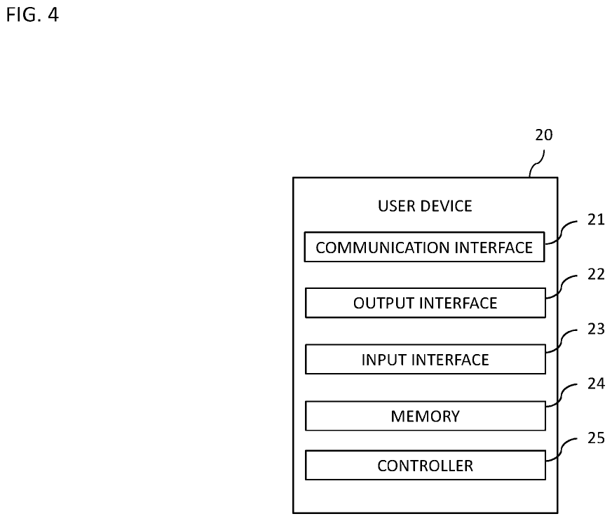

Referring now to FIG. 4, configurations of the user device 20 will be explained in detail. FIG. 4 is a block diagram illustrating a schematic configuration of the user device 20 shown in FIG. 1.

As illustrated in FIG. 4, the user device 20 includes a communication interface 21, an output interface 22, an input interface 23, a memory 24, and a controller 25. The communication interface 21, the output interface 22, the input interface 23, the memory 24, and the controller 25 are communicably connected to each other in a wired or wireless manner.

The communication interface 21 includes a communication module for connecting to the network 30. The communication module is, for example, a communication module compliant with a mobile communication standard such as the 4G standard or the 5G standard. The communication module may be, for example, a communication module compliant with a standard such as a wired LAN standard or a wireless LAN standard. The communication module may be a communication module compliant with a short-range wireless communication standard such as Wi-Fi, Bluetooth®, or an infrared communication standard. In the present embodiment, the user device 20 is connected to the network 30 via the communication interface 21. This enables the user device 20 to communicate with the server devices 10, and the like.

The output interface 22 includes at least one output device. The output device included in the output interface 22 is, for example, a display, a speaker, a lamp, or the like. The output interface 22 outputs images, sound, light, or the like.

The input interface 23 includes an input device. The input device included in the input interface 23 may, for example, be a keyboard, a mouse, a touch panel, a camera, a microphone, or the like. The input interface 23 accepts input operations from a user.

The memory 24 is, for example, a semiconductor memory, a magnetic memory, an optical memory, or the like. The memory 24 may function as, for example, a main memory, an auxiliary memory, or a cache memory. The memory 24 stores any information used for operations of the user device 20. For example, the memory 24 stores a system program, an application program, a database, embedded software, or the like. The information stored in the memory 24 may be updated with, for example, information acquired from the network 30 via the communication interface 21.

The controller 25 includes at least one processor. The processor may be, for example, a general-purpose processor such as a CPU, a dedicated processor that is dedicated to specific processing, or the like. The controller 25 is not limited to a processor and may include at least one dedicated circuit. Examples of dedicated circuits may include a FPGA and an ASIC. The controller 25 controls the above-described components such as the communication interface 21, the output interface 22, the input interface 23, and the memory 24 to realize the functions of the user device 20, including the functions of these components.

### First Operational Example of Construction Schedule Management System

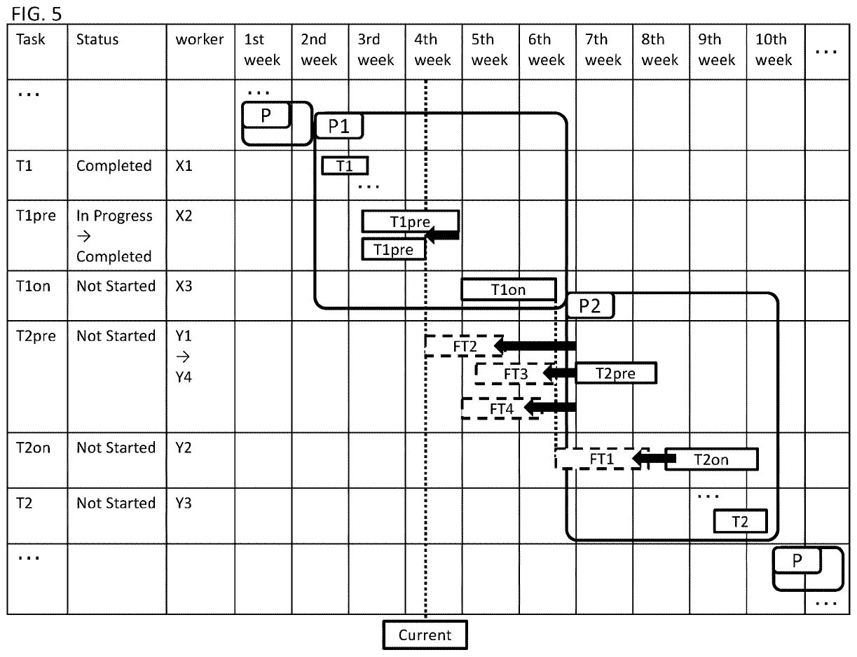

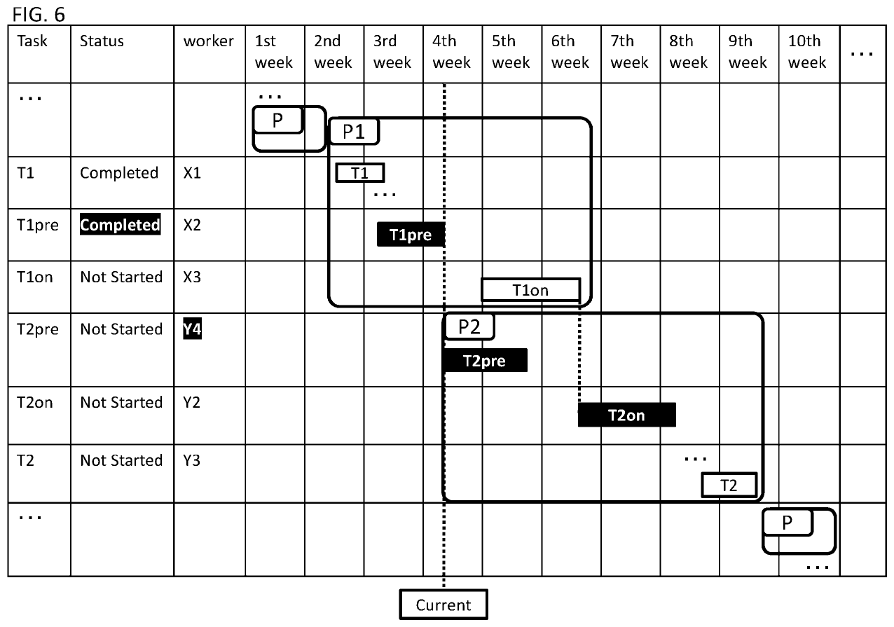

Referring to FIGS. 2, 5, and 6, operations of the construction schedule management system 1 regarding the management of construction schedule is described. FIG. 5 is an example of a construction schedule according to the present disclosure. FIG. 6 is an updated example of the construction schedule shown in FIG. 5. The flowchart in FIG. 2 illustrates the operations of the server device 10 and the user device 20 included in the construction schedule management system 1. Therefore, these operations correspond to a method for managing a construction schedule performed by the construction schedule management system 1, and also correspond to a method for managing a construction schedule performed by each of the server device 10 and the user device 20 included in the construction schedule management system 1.

As illustrated in FIG. 5, the construction schedule includes two or more phases P including a first phase P1 and a second phase P2. In the following, operations will be described in which the second phase P2 is brought forward based on the progress status of the first phase P1 by the construction schedule management system 1.

It is assumed that the user devices 20A-20C are used by contractors or workers thereof which are respectively assigned different phases in the construction schedule. Specifically, the user device 20A is used by a contractor (or its workers) assigned to the first phase P1, the user device 20B is used by a contractor (or its workers) assigned to the second phase P2, and the user device 20C is used by a contractor (or its workers) assigned to a phase other than the first and second phases P1 and P2.

Referring to FIG. 2, the server device 10 stores the construction schedule comprising two or more phases including the first phase P1 and the second phase P2 scheduled to begin after the first phase P1 begins (step S101).

Specifically, the controller 15 of the server device 10 stores the construction schedule in the memory 14. As shown in FIG. 5, in the present operational example, the construction schedule includes the first phase P1 and the second phase P2. The construction schedule may include any phase P in addition to the first phase P1 and the second phase P2. In the present operational example, the first phase P1 is a phase that is currently in progress, and the second phase P2 is a phase that has not yet begun. However, the second phase P2 may also be a phase currently in progress. In the example shown in FIG. 5, the second phase P2 is a phase scheduled subsequent to the first phase P1. The construction schedule may include other phases set between the first phase P1 and the second phase P2. That is, the two or more phases included in the construction schedule may include one or more phases scheduled to begin after the first phase P1 begins and before the second phase P2 begins.

Each of the phases P may comprises two or more tasks T including an on-site task Ton performed at the construction site and a corresponding pre-task Tpre scheduled to begin before the on-site task Ton begins. In the present operational example, the first phase P1 comprises two or more tasks T1 including a first on-site task T1on performed at the construction site and a first pre-task T1pre scheduled to begin before the first on-site task T1on begins. The second phase P2 comprises two or more tasks T2 including a second on-site task T2on performed at the construction site and a second pre-task T2pre scheduled to begin before the second on-site task T2on begins.

The on-site task Ton may be scheduled to begin after the corresponding pre-task Tpre ends in the construction schedule. In the present operational example, the first on-site task T1on is scheduled to begin after the first pre-task T1pre ends in the construction schedule. The second on-site task T2on is scheduled to begin after the second pre-task T2pre ends in the construction schedule. However, the on-site task Ton may be scheduled to begin after the corresponding pre-task Tpre begins but before it ends in the construction schedule.

Referring again to FIG. 2, the user device 20A transmits first progress status data including progress status of at least one of the tasks T1 included in the first phase P1 (step S102).

In this embodiment, a progress status data is information including the progress status of at least one of the tasks T included in one phase P in the construction schedule. The progress status of each task T may include a status, for example, “Not started”, “In progress”, “Suspended”, “Completed”, “New Start”, “Waiting on trade”, “Sent to construction site”, “Confirmed date”, “Dry run”, “Weather delay”, “Fail”, “Open punch item”, “Pass on first attempt”, “Waiting on contractor”, “Reinspection pass”, “Waiting on materials”, “Conditional approval”, or “Cancelled”. However, the progress status may include arbitrary information such as a numerical value from 1% to 100% when the completion of task T is 100%.

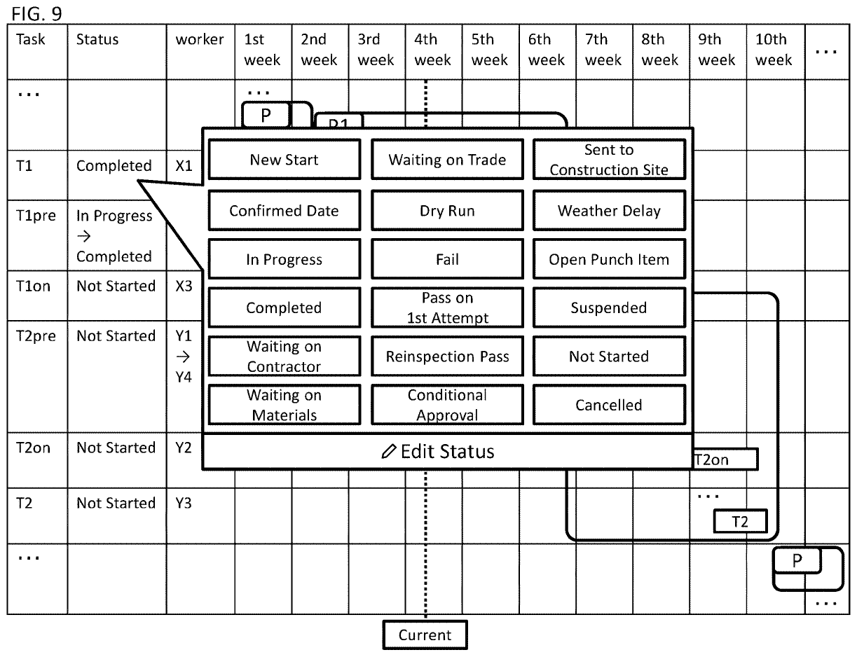

Any method can be employed for transmitting the first progress status data. For example, the controller 25 of the user device 20A may receive the progress status of the task T1 included in the first phase P1 as input via the input interface 23. For example, as shown in FIG. 9, the controller 25 may display, via the output interface 22, a user interface for editing the progress status of the tasks T. FIG. 9 is an example of a user interface for editing the progress status of the tasks T. The controller 25 may receive, via the input interface 23, an input for selecting one progress status from the displayed potential progress statuses of the task T1. The controller 25 may generate a first progress status data based on the input progress status. The controller 25 transmits the generated first progress status data to the server device 10 via the communication interface 21.

The operations in the step S102 may be repeatedly performed at predetermined timing. For example, the operations in the step S102 may be performed every time the input interface 23 receives a predetermined number of inputs. The predetermined number of inputs is, for example, one, but may be any number greater than or equal to one. Alternatively, the operations in the step S102 may be performed at predetermined time intervals. The predetermined time interval is, for example, one hour, but may be any time interval.

For example, it is assumed that in the construction schedule shown in FIG. 5, it is at the timepoint indicated as “Current” and the pre-task T1pre of the first phase P1 has been completed earlier than scheduled. A worker of the contractor assigned to the first phase P1 operates the input interface 23 of the user device 20A to input, as the progress status of the pre-task T1pre, that the pre-task T1pre is completed. Then, the user device 20A transmits first progress status data including progress status indicating that the pre-task T1pre is completed to the server device 10.

Referring again to FIG. 2, the server device 10 receives the first progress status data including progress status of at least one of the tasks T1 in the first phase P1 (step S103).

In the present operational example, the controller 15 of the server device 10 receives the first progress status data from the user device 20A via the communication interface 11. However, the controller 15 may receive the first progress status data in any manner. The controller 15 may receive the first progress status data from any computer or storage medium in addition to the user device 20A via the communication interface 11. The controller 15 may receive the first progress status data via the input interface 13. Then, the controller 15 may store the received first progress status data in the memory 14.

The controller 15 of the server device 10 may receive any information in addition to the first progress status data for use in subsequent processing, in the step S103. The controller 15 may store the received information in the memory 14 in association with the construction schedule. The information may be weather information. The weather information includes, for example, forecasts of the weather, temperature, humidity, or the like at the construction site. The controller 15 may store the received weather information in the memory 14 in association with the construction schedule as information regarding weather.

Referring to FIG. 2, the server device 10 updates the construction schedule based on the first progress status data to bring the second phase P2 forward (step S104).

The operations of the step S104 may include the operations of step S104-1 and step S104-2 as described below. Specifically, in the step S104-1, the server device 10 determines a target task to be brought forward among the tasks T2 in the second phase P2 based on the first progress status data.

Any method can be employed for determining a target task. In one example, the controller 15 of the server device 10 may use a start condition associated with each of the tasks T2 in the second phase P2 to determine a target task. The start condition may be stored in advance in the memory 14 in association with each of the tasks T2 in the second phase P2. In such a case, the controller 15 may determine a target task to be brought forward among the tasks T2 in the second phase P2 based on the first progress status data and the start condition of the each of the tasks T2, in the step S104-1.

For example, in the construction schedule shown in FIG. 5, if the controller 15 of the server device 10 receives the first progress status data including a progress status that the pre-task T1pre is completed at the current time indicated as “Current”, the controller 15 updates the status of the pre-task T1pre from “In progress” to “Completed” and updates the timeline of the pre-task T1pre in the construction schedule to end at the current time. Then, the controller 15 extracts, as target tasks, tasks T2 which is associated with the completion of pre-task T1pre as a start condition from among the tasks T2 included in the second phase P2. For example, when the second pre-task T2pre and the second on-site task T2on of the second phase P2 are associated with the completion of pre-task T1pre as the start condition, the controller 15 may determine each of the second pre-task T2pre and the second on-site task T2on to be the target task.

In another example, the controller 15 of the server device 10 may use a weather condition, under which the each of the tasks T2 can be performed, associated with each of the tasks T2 in the second phase P2 to determine a target task, in the step S104-1. The weather condition may be stored in advance in the memory 14 in association with each of the tasks T2 in the second phase P2. In such a case, the controller 15 may determine a target task to be brought forward among the tasks T2 in the second phase P2 based on the first progress status data and the weather information, in the step S104-1.

For example, in the construction schedule shown in FIG. 5, if the controller 15 of the server device 10 receives the first progress status data including a progress status that the pre-task T1pre is completed at the current time, the controller 15 updates the status of the pre-task T1pre from “In progress” to “Completed” and updates the timeline of the pre-task T1pre in the construction schedule to end at the current time. Then, the controller 15 retrieves weather information including the forecasted weather conditions after the current time. The controller 15 also retrieves weather data associated with tasks T2 in the second phase P2 under which the each of the tasks T2 can be performed. The controller 15 compares a weather condition associated with each of the tasks T2 and the forecasted weather data to determine a target task. When the forecasted weather data satisfies the weather conditions associated with the second pre-task T2pre and the second on-site task T2on of the second phase P2, the controller 15 may determine each of the second pre-task T2pre and the second on-site task T2on to be the target task.

Referring again to FIG. 2, the server device 10 brings the determined target task forward in the construction schedule (step S104-2).

In the step S104-2, the controller 15 of the server device 10 may determine how much to bring the target task forward based on predetermined conditions. The unit of time amount for bringing the target task forward may be arbitrarily determined. The unit of time amount may include, for example, one day, AM, PM, or three hours. Any method can be employed for determining how much to bring the target task forward.

In one example, the controller 15 may determine how much to bring the target task forward depending on whether the target task is an on-site task or a pre-task. In this state, if the target task is the second on-site task T2on of the second phase P2, the controller 15 of the server device 10 may reschedule the second on-site task T2on to begin after the first on-site task T1on ends in the construction schedule, in the step S104-2.

In the construction schedule shown in FIG. 5, when the second on-site task T2on is determined to be a target task, the controller 15 of the server device 10 does not prepone the start time of the second on-site task T2on to the current time. Instead, the controller 15 brings the second on-site task T2on forward to the time slot of the forwarded task FT1 so that it begins after the first on-site task T1on ends. With performing such an operation, the controller 15 can reduce the occurrence of a situation where multiple on-site tasks are simultaneously performed at the construction site and one of the on-site tasks interferes with the progress of the other on-site task. As a result, the controller 15 can reduce the risk of delays in the revised schedule.

Alternatively, the controller 15 of the server device 10 may reschedule the second pre-task T2pre to begin before the first on-site task T1on ends in the construction schedule when the target task is the second pre-task T2pre of the second phase P2, in the step S104-2.

In the construction schedule shown in FIG. 5, when the second pre-task T2pre is determined to be a target task, the controller 15 of the server device 10 brings the second pre-task T2pre forward to the time slot of the forwarded task FT2. That is, the controller 15 prepones the start time of the second pre-task T2pre to be before the end time of the first on-site task T1on. As such, with considering whether the target task is a pre-task or an on-site task, the controller 15 can bring the second phase P2 forward efficiently while reducing the risk that rescheduling of the second phase P2 affects the first phase P1. As a result, the controller 15 can reduce the risk of delays in the revised schedule.

In another example, the controller 15 of the server device 10 may determine how much to bring the target task forward by considering the entire time duration of the second phase P2 after being brought forward, in the step S104-2.

In this state, the controller 15 of the server device 10 may reschedule at least one of the second pre-task T2pre or the second on-site task T2on to shorten a time interval between the second pre-task T2pre and the second on-site task T2on, in the step S104-2.

In the construction schedule shown in FIG. 5, it is assumed that even though the second pre-task T2pre can be brought forward to the time slot of the forwarded task FT2, the second on-site task T2on can only be brought forward to the time slot of the forwarded task FT1 due to its relationship with the first on-site task T1on. In that case, the controller 15 of the server device 10 does not bring the second pre-task T2pre forward to the time slot of the forwarded task FT2. Instead, the controller 15 brings it forward to the time slot of the forwarded task FT3. This can shorten the time interval between the second pre-task T2pre and the second on-site task T2on. Thereby, the controller 15 can suppress an increase in the cost for securing workers for the second phase P2 due to the extension in the time duration of the second phase P2 caused by bringing forward some of the tasks T2 of the second phase P2.

In yet another example, the controller 15 of the server device 10 may determine how much to bring the target task forward based on the worker information about availability of workers assigned to each of the tasks T2 in the second phase P2, in the step S104-2. The controller 15 may store the worker information in memory 14 in advance.

in this state, the controller 15 of the server device 10 may bring the target task forward to a time slot where the worker assigned to the target task is available, in the step S104-2.

In the construction schedule shown in FIG. 5, when the second pre-task T2pre is a target task, the controller 15 of the server device 10 determines the time slot where the worker assigned to the second pre-task T2pre is available from the worker information stored in the memory 14. It is assumed that the worker for the second pre-task T2pre has already been assigned another task until the end of the 4th week. In such a case, even if it is possible to bring the second pre-task T2pre forward to the time slot of the forwarded task FT2, the controller 15 does not bring the second pre-task T2pre forward to the time slot of the forwarded task FT2. Instead, the controller 15 brings the second pre-task T2pre to the time slot of the forwarded task FT4 so that it starts in the 5th week when the worker for the second pre-task T2pre is available. Thereby, the controller 15 can reduce the risk that the rescheduled tasks will not be performed as rescheduled.

Alternatively, in the step S104-2, the controller 15 of the server device 10 may assign another worker in case where the worker assigned to the target task is not available for the new time slot.

In the construction schedule shown in FIG. 5, it is assumed that, as mentioned above, the second pre-task T2pre, as a target task, can be brought forward to the time slot of the forwarded task FT2, but the worker for the second pre-task T2pre has already been assigned another task until the end of the 4th week. In such a case, the controller 15 of the server device 10 accesses the worker information stored in the memory 14 and searches for another worker who is available during the time slot of the forwarded task FT2. The controller 15 may assign the searched another worker who is available during the time slot of the forwarded task FT2 as a new worker for the second pre-task T2pre and bring the second pre-task T2pre forward to the time slot of the forwarded task FT2. Thereby, the controller 15 can increase the probability that some of the tasks T2 in the second phase P2 can be brought forward.

As described above, the controller 15 of the server device 10 updates the construction schedule based on the first progress status data to bring the second phase forward in the step S104, by combining one or more of the operations described in the steps S104-1 and S104-2. An example of the construction schedule updated by the controller 15 of the server device 10 is shown in FIG. 6. The controller 15 may store the updated construction schedule in the memory 14 as a result of the operations in S104.

Referring again to FIG. 2, the server device 10 outputs the updated construction schedule (step S105).

Any method can be employed for outputting the updated construction schedule. For example, when the output interface 12 of the server device 10 includes a display, the controller 15 may show the updated construction schedule as shown in FIG. 6 on the display. In this case, as shown in FIG. 6, the updated contents in the construction schedule may be displayed in an emphasized manner. For another example, the controller 15 may transmit, via the communication interface 11, a command to output the updated construction schedule to the user devices 20A-20C. Thereby, the user devices 20A-20C can output the updated construction show as shown in FIG. 6 via the output interface 22 such as a display, as shown in the step S106 of FIG. 2.

Referring to FIG. 2, upon bringing the second phase P2 forward, the server device 10 selectively transmits a notification to a recipient associated with the second phase P2 (step S107).

Any method can be employed for transmitting a notification to a recipient. For example, the controller 15 of the server device 10 may store the recipient information regarding a recipient associated with each of the phase P, including the second phase P2, in advance in the memory 14. The controller 15 acquires the recipient information associated with the second phase P2 stored in the memory 14. The stored recipient may be information that can identify the user device 20, such as an IP address, an email address, or a telephone number. In this case, the controller 15 transmits, via the communication interface 11, a notification, such as an email, an SMS, or an instruction to display a push notification, to the user device 20B associated with the second phase P2. The notification may include information indicating that the second phase P2 has been brought forward, information about the task T2 that has been brought forward, including information such as the updated time slot, the updated worker, or the like. The notification may be created for each contractor regarding tasks assigned to all workers at the contractor, or may be created for each worker regarding tasks assigned to the worker. In contrast, the controller 15 does not transmit notifications to the user devices 20A and 20C that are not associated with the second phase P2. Thereby, only the user device 20B can output, via the output interface 22 such as a display, that the second phase P2 has been brought forward. By selectively transmitting notifications in this manner, the controller 15 can prevent transmitting unnecessary notifications to contractors or workers of the tasks that have not been updated in the construction schedule.

As described above, the server device 10, which is a construction schedule management apparatus, according to the present embodiment stores a construction schedule comprising two or more phases P including a first phase P1 and a second phase P2 scheduled to begin after the first phase P1 begins. The server device 10 receives first progress status data including progress status of at least one of the tasks T1 in the first phase P1, for example, from the user device 20A. The server device 10 updates the construction schedule based on the first progress status data to bring the second phase P2 forward. The server device 10 outputs the updated construction schedule, for example, to the user devices 20A-20C.

According to such a configuration, the server device 10, which is a construction schedule management apparatus, can dynamically bring forward a task T included in a construction schedule in relation to the progress status of other tasks T included in the construction schedule. Accordingly, the server device 10 can shorten the overall period of the construction schedule. Therefore, the construction schedule management system 1 according to the present embodiment enables to further improve the efficiency of construction schedule management and optimize the construction schedule.

### Second Operational Example of Construction Schedule Management System

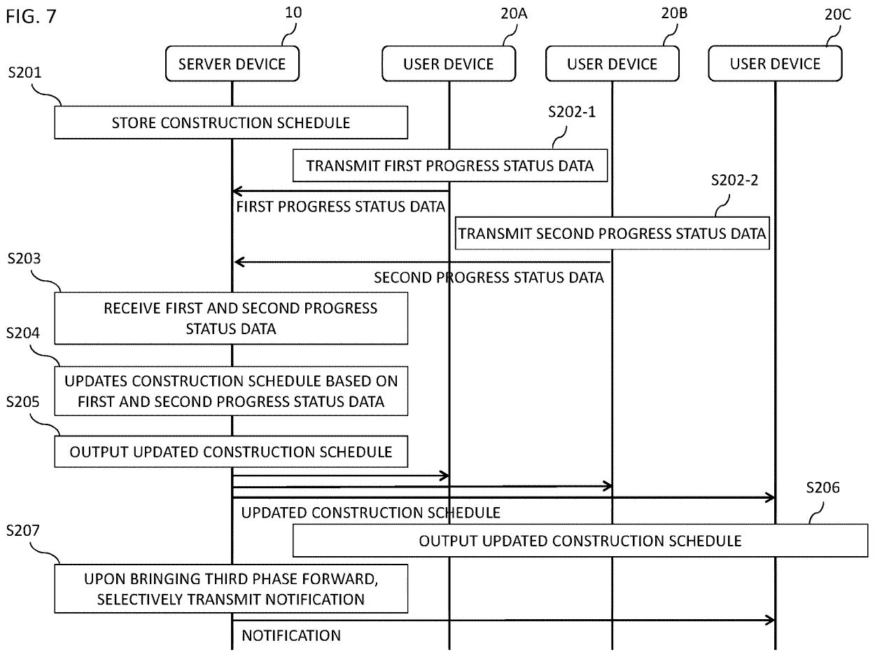

In the first operational example, a case has been explained in which the controller 15 of the server device 10 updates the construction schedule based on the progress status data of one of the phases P scheduled in the construction schedule, in the construction schedule management system 1. However, the controller 15 may update the construction schedule based on progress status data of two or more phases P. With reference to FIG. 7, a second operational example for managing the construction schedule provided by the construction schedule management system 1 is described. FIG. 7 is a flowchart showing a second operational example of a construction schedule management system 1 shown in FIG. 1. In this second operational example, a description will be given of an operation in which the third phase P3 is brought forward based on the progress status of the first phase P1 and the progress status of the second phase P2, in the construction schedule management system 1.

In the present operational example, for example, the construction schedule explained in the first operational example further includes a third phase P3 scheduled to begin after the second phase P2 begins, in addition to the first phase P1 and the second phase P2. The third phase P3 comprises two or more tasks T3 including a third on-site task T3on performed at the construction site and a third pre-task T3pre scheduled to begin before the third on-site task T3on begins.

In the step S201, the controller 15 of the server device 10 stores, in the memory 14, the construction schedule comprising two or more phases including the first phase P1, the second phase P2, and the third phase P3, in the similar manner as described above at the step S101 in the first operational example (step S201).

In the step S202-1, the controller 25 of the user device 20A transmits first progress status data including progress status of at least one of the tasks T1 included in the first phase P1, in the similar manner as described above at the step S102 in the first operational example. In the step S202-2, the controller 25 of the user device 20B also transmits second progress status data including progress status of at least one of the tasks T2 included in the second phase P2.

In the step S203, the controller 15 of the server device 10 receives the first progress status data and the second progress status data, in the similar manner as described above at the step S103 in the first operational example.

In the step S204, the controller 15 of the server device 10 updates the construction schedule based on the first progress status data and the second progress status data to bring the third phase P3 forward, in the similar manner as described above at the step S104, including the steps S104-1 and S104-2, in the first operational example.

In the step S205, the controller 15 of the server device 10 outputs the updated construction schedule, in the similar manner as described above at the step S105 in the first operational example. For an example, the controller 15 may output, via the output interface 12, the updated construction schedule. For another example, the controller 15 may transmit, via the communication interface 11, a command to output the updated construction schedule to the user devices 20A-20C. Thereby, the user devices 20A-20C can output, via the output interface 22, the updated construction schedule in the step S206.

In the step S207, upon bringing the third phase P3 forward, the controller 15 of the server device 10 selectively transmits a notification to a recipient associated with the third phase P3, in the similar manner as described above at the step S107 in the first operational example. The controller 15 transmits, via the communication interface 11, a notification, such as an email, an SMS, or an instruction to display a push notification, to the user device 20C associated with the third phase P3. In contrast, the controller 15 does not transmit a notification to the user devices 20A and 20B that are not associated with the third phase P3.

As described above in the second operational example, the controller 15 of the server device 10 can bring the third phase P3 forward more appropriately than in the first operational example, by using progress status data regarding two or more phases P scheduled in the construction schedule. However, the controller 15 may update the construction schedule based on progress status data regarding an arbitrary number of phases P included in the construction schedule, not limited to the manners described above in the first operational example and the second operational example.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions included in each component, operations included in each step, or the like can be rearranged without logical inconsistency, and a plurality of components, steps, or the like can be combined into one or divided.

For example, an embodiment in which a general-purpose computer functions as the server device 10 according to the above embodiments can also be implemented. Specifically, a program in which processes for realizing the functions of the server device 10 according to the above embodiment are written may be stored in a memory of the general-purpose computer, and the program may be read and executed by a processor of the general-purpose computer. Accordingly, the present disclosure can also be implemented as a program executable by a processor, or a non-transitory computer readable medium storing the program. Examples of the non-transitory computer readable medium include a magnetic storage device, an optical disc, a magneto-optical storage device, and a semiconductor memory.

For example, in the embodiments described above, the server device 10 acts as a construction schedule management device. However, not limited the above-mentioned embodiments, the user device 20 may be configured to execute some or all of the operations and processing performed by the server device 10 as a construction schedule management device. In such a case, the user device 20 may be configured to perform some or all of the operations and processing performed by the server device 10.

For example, in the embodiments described above, the controller 15 of the server device 10 selectively transmits, via the communication interface 11, a notification, such as an email, an SMS, or an instruction to display a push notification, to the user device 20. However, not limited the above-mentioned embodiments, notifications may include telephone calls, letters, and the like. In such a case, the controller 15 may display, via the output interface 12 such as a display, an instruction to selectively transmit a notification. This allows the operator of the server device 10 to make a call or send a letter to selectively transmit a notification.

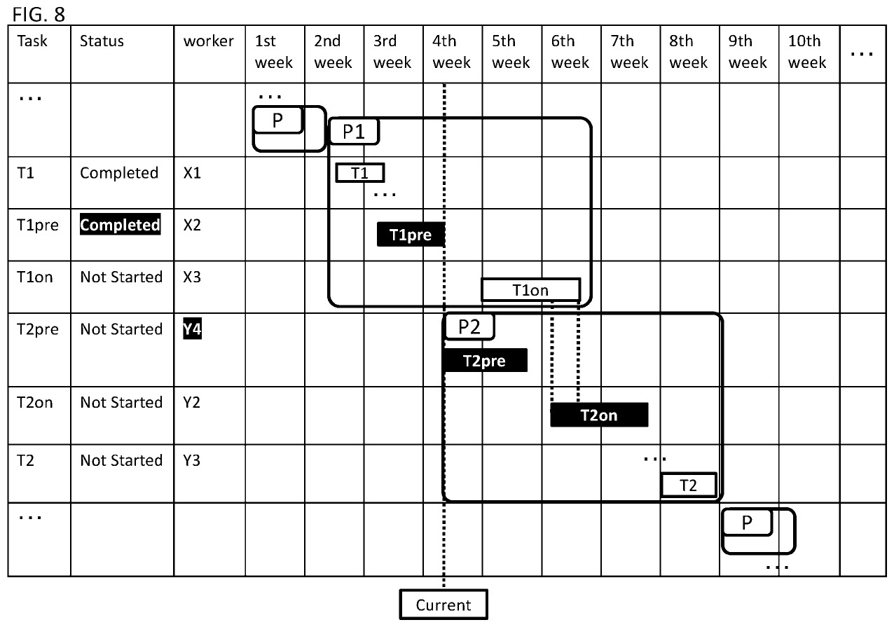

For example, in the first operational example, two or more on-site tasks Ton are not scheduled to be performed simultaneously in one construction schedule. However, as shown in FIG. 8, the controller 15 of the server device 10 may schedule two or more on-site tasks Ton (for example, the first on-site task T1on and the second on-site task T2on) to be performed simultaneously. FIG. 8 is another updated example of the construction schedule shown in FIG. 5. In this case, the controller 15 may store in the memory 14 the information as to whether each of the on-site tasks Ton can be performed simultaneously with another on-site task Ton or not, in association with each of the on-site tasks Ton. Referring to FIGS. 2 and 8, in step S104-2, if the target task is the second on-site task T2on of the second phase P2, the controller 15 may determine whether both the first on-site task T1on of the first phase P1 and the second on-site task T2on of the second phase P2 can be performed simultaneously with another on-site task Ton. If both the first on-site task T1on and the second on-site task T2on can be performed simultaneously with another on-site task Ton, the controller 15 may schedule the first on-site task T1on and the second on-site task T2on to be performed simultaneously, as shown in FIG. 8. As a result, the controller 15 bring the target task forward efficiently.

### NUMERICAL REFERENCES IN FIGURES

1: Construction schedule management system,
10: Server device,
11: Communication interface,
12: Output interface,
13: Input interface,
14: Memory,
15: Controller,
20 (20A, 20B, 20C): User device,
21: Communication interface,
22: Output interface,
23: Input interface,
24: Memory,
25: Controller,
30: Network,
P: Phase (P1: First phase, P2: Second phase, P3: Third phase),
T: Task (T1: Task in the first phase P1, T2: Task in the second phase P2),
Tpre: Pre-task (T1pre: First pre-task, T2pre: Second pre-task),
Ton: On-site task (T1on: First on-site task, T2on: Second on-site task),
FT (FT1, FT2, FT3, FT4, FT5): Forwarded task.

1. A method for managing a construction schedule, the method comprising:
storing, by a computer, the construction schedule comprising two or more phases including a first phase and a second phase scheduled to begin after the first phase begins, wherein the first phase comprises two or more tasks including a first on-site task performed at a construction site and a first pre-task scheduled to begin before the first on-site task begins, and the second phase comprises two or more tasks including a second on-site task performed at the construction site and a second pre-task scheduled to begin before the second on-site task begins;
receiving, by the computer, first progress status data including progress status of at least one of the tasks in the first phase;
updating, by the computer, the construction schedule based on the first progress status data to bring at least one of the second on-site task or the second pre-task forward to shorten a time interval between the first on-site task and the second on-site task, wherein the first on-site task includes physical work or manufacturing, and the second on-site task includes physical work or manufacturing; and
outputting, by the computer, the updated construction schedule.

2. The method according to claim 1, wherein
the updating the construction schedule comprises rescheduling the second on-site task to begin after the first on-site task ends in the construction schedule to prevent the first on-site task and the second on-site task from being performed simultaneously at the construction site.

3. The method according to claim 1, wherein
the updating the construction schedule comprises rescheduling the second pre-task to begin before the first on-site task ends in the construction schedule.

4. The method according to claim 1, wherein
the updating the construction schedule comprises rescheduling the at least one of the second pre-task or the second on-site task to shorten a time interval between the second pre-task and the second on-site task.

5. The method according to claim 1, wherein
each of the tasks in the second phase is stored in association with a start condition,
the updating the construction schedule comprises:
determining a target task to be brought forward among the tasks in the second phase based on the first progress status data and the start condition of the each of the tasks; and
bringing the target task forward.

6. The method according to claim 1, wherein
each of the tasks in the second phase is stored in association with a weather condition under which the each of the tasks can be performed,
the method further comprises receiving, by the computer, weather information, and
the updating the construction schedule comprises:
determining a target task to be brought forward among the tasks in the second phase based on the first progress status data and the weather information; and
bringing the target task forward.

7. The method according to claim 1, wherein
the two or more phases further include a third phase scheduled to begin after the second phase begins,
the third phase comprises two or more tasks including a third on-site task performed at the construction site and a third pre-task scheduled to begin before the third on-site task begins, and
the method further comprises:
receiving, by the computer, second progress status data including progress status of at least one of the tasks in the second phase; and
updating, by the computer, the construction schedule based on at least one of the first progress status data or the second progress status data to bring the third phase forward.

8. The method according to claim 1, wherein
the two or more phases further include one or more phases scheduled to begin after the first phase begins and before the second phase begins.

9. The method according to claim 1, wherein
the first on-site task is scheduled to begin after the first pre-task ends in the construction schedule, and
the second on-site task is scheduled to begin after the second pre-task ends in the construction schedule.

10. The method according to claim 1, wherein the second pre-task comprises at least one of:
finalizing a timeline of the second on-site task;
arranging a worker for the second on-site task;
requesting an additional worker for the second on-site task;
waiting until a weather condition permits the second on-site task to be performed; or
waiting until materials used in the second on-site task is delivered at the construction site.

11. The method according to claim 1, further comprising:
storing, by the computer, recipient information associated with the second phase; and
upon bringing the second phase forward, selectively transmitting, by the computer, a notification to the recipient.

12. The method according to claim 1, further comprising:
storing, by the computer, worker information about availability of workers assigned to each of the tasks in the second phase, wherein
the updating the construction schedule comprises:
determining a target task to be brought forward among the tasks in the second phase based on the first progress status data; and
bringing the target task forward to a time slot where the worker assigned to the target task is available.

13. The method according to claim 1, wherein
storing, by the computer, worker information about availability of workers assigned to each of the tasks in the second phase, wherein
the updating the construction schedule comprises:
determining a target task to be brought forward among the tasks in the second phase based on the first progress status data;
bringing the target task forward to a new time slot; and
in case where the worker assigned to the target task is not available at the new time slot, assigning another worker to the target task.

14. A system for managing a construction schedule, the system comprising a controller configured to execute operations, the operations comprising:
storing the construction schedule comprising two or more phases including a first phase and a second phase scheduled to begin after the first phase begins, wherein the first phase comprises two or more tasks including a first on-site task performed at a construction site and a first pre-task scheduled to begin before the first on-site task begins, and the second phase comprises two or more tasks including a second on-site task performed at the construction site and a second pre-task scheduled to begin before the second on-site task begins;
receiving first progress status data including progress status of at least one of the tasks in the first phase;
updating the construction schedule based on the first progress status data to bring at least one of the second on-site task or the second pre-task forward to shorten a time interval between the first on-site task and the second on-site task, wherein the first on-site task includes physical work or manufacturing, and the second on-site task includes physical work or manufacturing; and
outputting the updated construction schedule.

15. The system according to claim 14, wherein
the updating the construction schedule comprises rescheduling the second on-site task to begin after the first on-site task ends in the construction schedule to prevent the first on-site task and the second on-site task from being performed simultaneously at the construction site.

16. The system according to claim 14, wherein
the updating the construction schedule comprises rescheduling the second pre-task to begin before the first on-site task ends in the construction schedule.

17. The system according to claim 14, wherein
the updating the construction schedule comprises rescheduling the at least one of the second pre-task or the second on-site task to shorten a time interval between the second pre-task and the second on-site task.

18. The system according to claim 14, wherein
each of the tasks in the second phase is stored in association with a start condition,
the updating the construction schedule comprises:
determining a target task to be brought forward among the tasks in the second phase based on the first progress status data and the start condition of the each of the tasks; and
bringing the target task forward.

19. The system according to claim 14, wherein
each of the tasks in the second phase is stored in association with a weather condition under which the each of the tasks can be performed,
the operations further comprise receiving weather information, and
the updating the construction schedule comprises:
determining a target task to be brought forward among the tasks in the second phase based on the first progress status data and the weather information; and
bringing the target task forward.

20. The system according to claim 14, wherein
the two or more phases further include a third phase scheduled to begin after the second phase begins,
the third phase comprises two or more tasks including a third on-site task performed at the construction site and a third pre-task scheduled to begin before the third on-site task begins, and
the operations further comprises:
receiving second progress status data including progress status of at least one of the tasks in the second phase; and
updating the construction schedule based on at least one of the first progress status data or the second progress status data to bring the third phase forward.

21. The system according to claim 14, wherein the second pre-task comprises at least one of:
finalizing a timeline of the second on-site task;
arranging a worker for the second on-site task;
requesting an additional worker for the second on-site task;
waiting until a weather condition permits the second on-site task to be performed; or
waiting until materials used in the second on-site task is delivered at the construction site.

22. The system according to claim 14, wherein the operations further comprises:
storing recipient information associated with the second phase; and
upon bringing the second phase forward, selectively transmitting a notification to the recipient.

23. The system according to claim 14, wherein the operations further comprises:
storing worker information about availability of workers assigned to each of the tasks in the second phase, and
the updating the construction schedule comprises:
determining a target task to be brought forward among the tasks in the second phase based on the first progress status data; and
bringing the target task forward to a time slot where the worker assigned to the target task is available.

24. The system according to claim 23, wherein the operations further comprises:
storing worker information about availability of workers assigned to each of the tasks in the second phase, and
the updating the construction schedule further comprises:
determining a target task to be brought forward among the tasks in the second phase based on the first progress status data;
bringing the target task forward to a new time slot; and
in case where the worker assigned to the target task is not available at the new time slot, assigning another worker to the target task.
